(19) United States
(12) Patent Application Publication
(10) Pub. No.: US 2008/0212617 A1
(43) Pub. Date: Sep. 4, 2008

(54) System and method for synchronization of time sensitive user events in a network

(75) Inventors: Robert S. Flesch, Atlanta, GA (US); Dave Williams, Atlanta, GA (US); James H. Pittman, Snellville, GA (US)

Correspondence Address: TIMOTHY F. BLISS, P.O. BOX 741715, DALLAS, TX, 75374-1715, US

(73) Assignee: Proto Terra, Inc., Atlanta, GA (US)

(21) Appl. No.: 11/712,790

(22) Filed: Mar. 1, 2007

(51) Int. Cl. H04J 3/06

(52) U.S. Cl. 370/503

(57) ABSTRACT

The present disclosure relates generally to systems and methods for synchronization of time sensitive user events in a network. In one example, the method includes receiving an event from a client during a time window and receiving another event from another client during the time window. The events, which are considered to have occurred simultaneously due to their arrival within the same time window, are combined into a picture packet and the picture packet is sent to the first and second clients for execution.

### BACKGROUND

The level of synchronization provided by computer networks generally allows for, at most, prediction based synchronization of actions occurring in sub-second timeframes. For example, two networked users may separately view a series of events that are the result of actions taken by both users. To each individual user, the events appear to be synchronized on their system even though the events may not be synchronized between the two systems. This local synchronization may occur because each of the systems has synchronized the events for that user. In such a situation, one user may be viewing the events correctly (i.e., in their proper order), and the other user may be viewing the events correctly at a slightly later time (e.g., one second or more). This lack of actual synchronization between the systems may be due to issues such as latency, which is the delay introduced as the events move through the network to each system. Due to this lack of synchronization between systems, the synchronization of highly time sensitive events is difficult to achieve in many network environments and prediction based synchronization is not satisfactory for such events. Accordingly, an improved system and method for synchronizing events in a network are needed.

### SUMMARY

In one embodiment, a method comprises determining a latency threshold based on a musical tempo and setting a time window based on the latency threshold, wherein events received during the time window are considered to be simultaneous. First and second events are received from the first and second clients, respectively, during the time window. The first and second events are combined into a picture packet after the time window ends, wherein the picture packet includes all information needed by each of the first and second clients to execute the first and second events. The picture packet is sent to the first and second clients for execution.

In another embodiment, a method comprises receiving a first event from a first client during a first time window and receiving a second event from a second client during the first time window. The first and second events are combined into a picture packet, wherein the first and second events are considered to have occurred simultaneously due to their arrival within the first time window. The picture packet is sent to the first and second clients for execution.

In still another embodiment, a method comprises sending an event to a server, wherein the event indicates a user action in a music session controlled by the server. A picture packet containing a plurality of simultaneous events is received from the server, wherein the picture packet includes the event sent to the server. The events are extracted from the picture packet and executed substantially simultaneously.

In yet another embodiment, a system comprises a network interface, a processor coupled to the network interface, a memory coupled to the processor for storing instructions for execution by the processor, and a plurality of instructions for a metronome process. The instructions include instructions for receiving a first event from a first client during a time window, receiving a second event from a second client during the time window, combining the first and second events into a picture packet, wherein the first and second events are considered to have occurred simultaneously due to their arrival within the time window, and sending the picture packet via the network interface to the first and second clients for execution.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart illustrating one embodiment of a method for synchronizing time sensitive user events in a network.

FIG. 2 is a block diagram of one embodiment of a system in which the method of FIG. 1 may be implemented.

FIG. 3 is a sequence diagram of one embodiment of data flow between components of the system of FIG. 2.

FIG. 4 is a flowchart of one embodiment of a method that may be used to determine whether to accept events from a client within the system of FIG. 2.

FIG. 5 is a flowchart of one embodiment of a method that may be used to set a time window within the system of FIG. 2.

FIG. 6 is a flowchart of one embodiment of a method that may be used by a client within the system of FIG. 2.

FIG. 7 is a block diagram of a more detailed embodiment of the system of FIG. 2 and data flow within the system.

### DETAILED DESCRIPTION

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

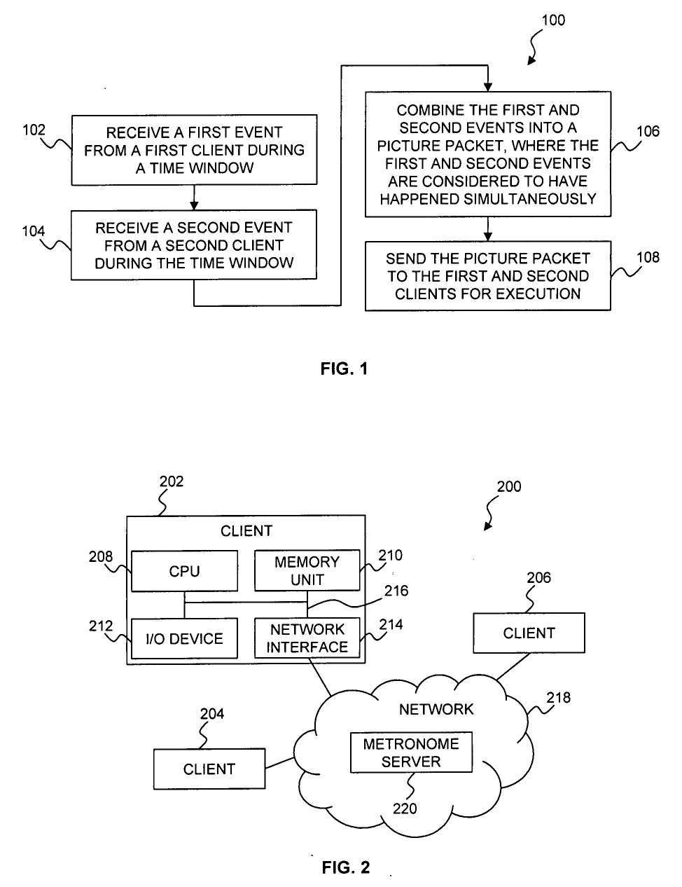

Referring to FIG. 1, in one embodiment, a method 100 illustrates the synchronization of related user events between clients in a network. As will be described later in greater detail, the related user events may be musical notes or other data (e.g., visual effects and/or animations) with which real-time synchronization is important. For example, if two networked users are collaborating in real time to create music via their computers, then actual synchronization is needed as well as a chronological ordering of the events. In other words, not only should the notes be played in the correct order, but each user should hear the notes substantially simultaneously if they are to continue playing the music. For this reason, separately synchronizing the events on each client (i.e., relying on client side synchronization) is generally not sufficient, as even if each user hears the notes in the correct order, they may not hear the notes at the same time as the other user.

In steps 102 and 104, respectively, a server or other network component receives one or more events from multiple clients during a time window. These events are considered to have occurred simultaneously since they arrived during the same time window. Accordingly, a client may be some fraction of a second off (with a tolerance equal to the size of the time window) due to network latency and/or human error, and still have the event synchronized with events submitted by other clients during that time window. Although time windows may vary in size depending on factors such as synchronization tolerance and latency, they are between one hundred and two hundred milliseconds in the present example. It is understood that not all clients may send an event during each time window. In cases where a client does not send an event during a time window, the client may send a blank event or otherwise notify the server that it has no event, or may simply not send any information to the server.

In step 106, the server combines the events received during the time window into a picture packet that provides a complete picture of what should occur at the specific moment that the picture packet arrives at a client. For example, the combination may involve extracting (e.g., decapsulating) event information received from the clients and encapsulating it in another form, or may involve inserting the events into the picture packet using the format in which they were received.

The events themselves may include atomic actions and/or state-driven actions (i.e., repetition of a sequence of atomic actions). For example, with music, an atomic action may be a code or other indicator representing a single note played by a particular instrument. A state may then be defined as a series of such notes, either played by a single instrument or multiple instruments. In other words, the state-driven event information may be a loop of music composed of various atomic actions and changing states may indicate the use of a different loop of music. Other atomic actions or states may then be combined to form a musical arrangement.

In step 108, the picture packet is sent to the first and second clients. If no events have been submitted during a time window, an empty packet beat may be sent to help users keep time (in the case of a music session). As will be described later in greater detail, the sending may be synchronized based on client latency or other factors to better control the actual time the picture packet reaches each client.

Generally, the method 100 may provide various advantages to a networked activity that should be synchronized in real-time, such as playing music. Unlike some activities, music and other time-sensitive sessions inherently contain a concept of correctness. For example, if music or any time-sensitive coordinated performance is played off-beat, out of tune, or out of key, the very nature of the music may be destroyed. Furthermore, music has a virtually limitless data set, and music and similar activities have little or no tolerance for estimating or approximating synchronization and responsiveness. Accordingly, prediction based solutions are not satisfactory as they fail to synchronize clients more closely than a significant fraction of a second, which is not within the tolerance of error for music and similar highly time sensitive activities. The method 100 may be used to address such issues by enabling participants (i.e., clients) to be synchronized despite variable network latencies, to receive near-immediate feedback, to be informed as to when others intended for an action or state change to occur, and to receive data in a regular and measured manner in near real-time.

Referring now to FIG. 2, an exemplary network 200 illustrates one environment within which the method 100 of FIG. 1 may be executed. The network 200 includes multiple clients 202, 204, and 206. Each client may be a computer, personal digital assistant (PDA), cellular telephone, or any other device capable of transmitting, processing, and/or receiving signals via wireless and/or wireline communication links. In the present embodiment, the clients 202, 204, and 206 are computers.

For purposes of example, the client 202 is illustrated in greater detail. The client 202 may include a central processing unit (“CPU”) 208, a memory unit 210, an input/output (“I/O”) device 212, and a network interface 214. The network interface may be, for example, one or more network interface cards (NICs) that are each associated with a media access control (MAC) address. The components 208, 210, 212, and 214 are interconnected by a bus system 216. It is understood that the client may be differently configured and that each of the listed components may actually represent several different components. For example, the CPU 208 may actually represent a multi-processor or a distributed processing system; the memory unit 210 may include different levels of cache memory, main memory, hard disks, and remote storage locations; and the I/O device 212 may include monitors, keyboards, electronic musical instruments, and the like.

The client 202 may be connected to a network 218. The network 218 may include any electronic transport medium, as well as network infrastructure (not shown) needed to provide such support, such as servers and routers. The network 218 may be, for example, a local area network (LAN), a wide area network (WAN), a company wide intranet, and/or the Internet. Furthermore, the network 218 may support wireless and/or wired communications using a variety of protocols. In the present example, the network 218 includes a metronome server 220 coupled to each of the clients 202, 204, and 206, although it is understood that the metronome server 220 may be connected to the network 218 in a manner similar to that of the clients 202, 204, and 206. The metronome server 220 may communicate directly with the clients 202, 204, and 206, or may communicate with other servers (not shown) that in turn communicate with the clients. Although not shown, the metronome server 220 may include various components as described with respect to the client 202.

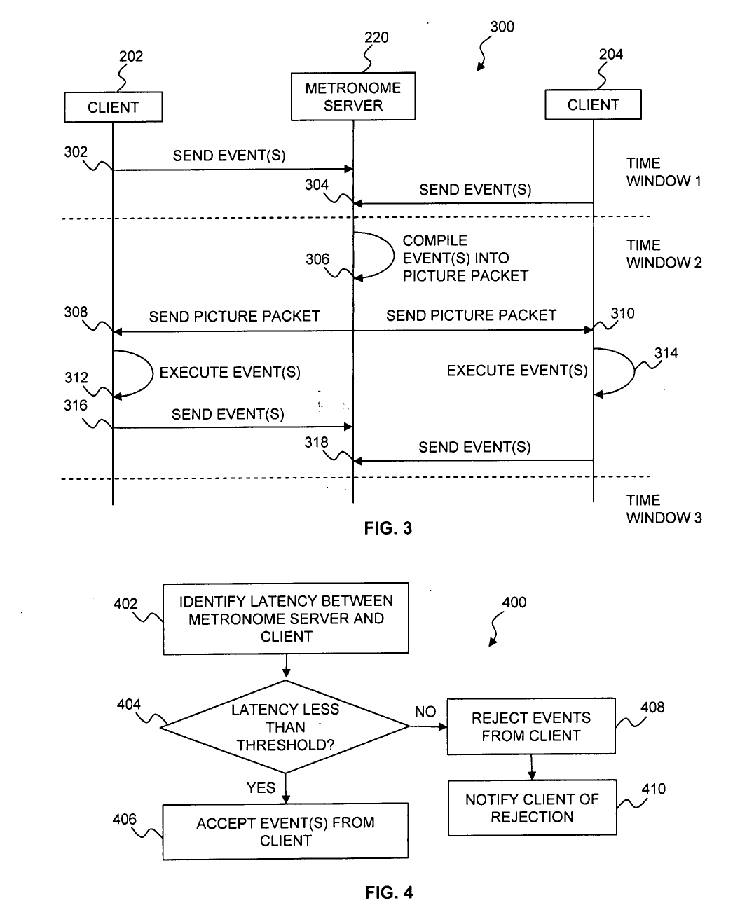

Referring to FIG. 3, a sequence diagram 300 illustrates one embodiment of the flow of data between clients 202 and 204 and metronome server 220 of system 200 of FIG. 2. In the present example, the metronome server 220 is configured to deliver time-critical sequenced data packets to clients 202 and 204, which are participating in a particular session (e.g., a music session). The data packets are to be delivered in a regular and metered fashion at substantially the same time for each sequence number. Although not shown in FIG. 3, it is understood that the sequence numbers may be associated with the time windows, so time window one may correspond to sequence number one, etc. Although a time window may be set for any desired time period, each time window in the present embodiment is two hundred milliseconds.

In steps 302 and 304, clients 202 and 204, respectively, send event information to the metronome server 220. This occurs during time window one. Multiple events may be sent by a single client during a single time window, and a client may not send an event at all in a given time window. Although FIG. 3 illustrates client 202 as sending event information prior to client 204, it is understood that client 204 may send event information first or both clients may send event information simultaneously. Furthermore, as a client may send multiple events during a single time window, a client may send an event both before and after an event is sent by another client.

At the end of time window one and the beginning of time window two, the metronome server 220 compiles the events into a picture packet as previously described. It is noted that, if a user intends for an event to reach the metronome server 220 in time window one, but the event instead reaches the metronome server during a later time window (i.e., time window two), the event may be handled normally during time window two. For example, with a two hundred millisecond time window, it may be difficult for the user to ensure that the event reaches the metronome server 220 in the correct time window, due to issues such as the user's skill and/or the graphical user interface with which the user is interacting.

However, this “bumping” of an event to the next window may be acceptable with a two hundred millisecond tempo (in the case of a music session). For example, assume that the user has an approximately one hundred millisecond ping (round-trip) to/from the metronome server 220. If the user sends the event to the metronome server 220 during approximately the first one hundred and forty-nine (t0-t149) milliseconds of the time window, it will reach the server by the end of the time window (given the approximately fifty millisecond travel time) and the users will hear the event coming on the next “beat”. If the user sends the event during the last fifty milliseconds of the time window (t150-t199), it will not arrive at the metronome server 220 until the next time window begins at t200. In this case, the event will be included in the next time window (t200-t399) and will not reach the user until approximately fifty milliseconds after that at around t450. Accordingly, this example provides a possible upper end response time of approximately 300 milliseconds.

If the user is playing music in a group with other networked users, the user would be late if everyone else sent in their events during the first window. For some events in a music session, such as a drum sound or bass sound, sending in the event late may be extremely noticeable, while other events may be less noticeable. As such, it may be desirable for more skilled users (in terms of timing) to be on percussive instruments like drums, and for lesser skilled users to be on the lead. It is noted that this may involve data shaping (discussed later), with the more percussive instruments generally being more difficult to shape.

In steps 308 and 310, the metronome server 220 then sends the picture packet to clients 202 and 204, respectively. The metronome server 220 may unicast the picture packet to each of the clients 202 and 204 or may broadcast the picture packet. If a unicast method is used, the unicast may be based on latency, as will be discussed later. While the metronome server 220 broadcasts the picture packet to listening clients (i.e., clients not actively participating in the session, such as the client 206 of FIG. 2) in the present example, unicast may also be used with listening clients.

In steps 312 and 314, respectively, clients 202 and 204 extract the event information from the picture packet and execute it substantially simultaneously. As the picture packet contains the combined information for both clients, client 202 is receiving the information it sent in step 302 and client 204 is receiving information it sent in step 304. In steps 316 and 318, clients 202 and 204, respectively, may send new event information to the metronome server 220. Time window two then ends and time window three begins.

It is understood that the actual order of steps and their positioning within a particular time window may vary. For example, events may arrive at the metronome server 220 as soon as time window two begins and before the metronome server begins compiling the event information for the picture packet. Such events may be stored until the end of time window two and then added to the picture packet as described. Accordingly, many variations may be made to the illustrated order of receiving events by the metronome server 220, forming the picture packet, and sending the picture packet out to the clients 202 and 204.

Furthermore, it is understood that the illustrated window size of two hundred milliseconds may be somewhat arbitrary. For example, with a one hundred millisecond ping, it is possible for a user to successfully submit events to a system having a window size of less than two hundred milliseconds. It may be difficult to calculate the smallest theoretical window size that still allows a user to submit an event during a current window, because upstream and downstream latency is often asymmetric, and the latency itself may fluctuate widely based on any number of factors, including network traffic, bandwidth, etc.

Accordingly, the example window size of two hundred milliseconds may be a balance between a margin for error and usefulness. For example, assume the window is set to ten seconds. Due to the large margin of error, each user participating in the music session will almost certainly submit their event(s) within the ten second window, regardless of latency, but such a window size is not useful for creating music.

In addition, a user may intentionally time the submission of an event to occur in the next (n+1) window, because it is easier to ensure that the event will be included when the picture packet for the n+1 window is created. For example, assume the window size is one hundred milliseconds. A user will likely miss the current (n) window, but the n+1 window with a one hundred millisecond duration may return to the user more quickly than the n+1 window with a two hundred millisecond duration. Accordingly, there may be value in aiming for the “wrong” window, because the event is more likely to be processed in that window, making it easier to play a regular beat.

If the users all understand which window is being aimed for, this approach of intentionally aiming for a later window may be successful, with the tradeoff being a slightly longer response time. So if a user is not aiming for the n window, and instead wants to aim for the n+m window, the user may actually prefer the one hundred millisecond window over the two hundred millisecond window because the shorter window gives finer granularity. However, the one hundred millisecond window may negatively impact the user by making the user more susceptible to lag spikes due to the shorter window. Accordingly, the window size for a given session, such as a music session, may be at least somewhat dependent on the users involved (e.g., their skill and/or preferences) rather than being based solely on technical issues such as latency.

Referring to FIG. 4, in another embodiment, a method 400 may be used to determine whether a client's events will be processed by a server, such as the metronome server 220 of FIG. 2. In the present example, the client (e.g., the client 202 of FIG. 2) is attempting to participate in a session that uses time sensitive synchronization as previously described. Rather than allowing any client to participate in the session, the method 400 may be used to screen clients. In some embodiments, if the client only wants to passively participate in the session (e.g., listen to music rather than create it), then the method 400 may not be executed for that client.

In step 402, a level of latency between the client 202 and the metronome server 220 is identified. This may be accomplished by pinging the client 202 or by using other known processes. In step 404, a determination may be made as to whether the client's latency is above a defined maximum threshold. For example, the threshold may be defined as a maximum amount of latency that will still permit a desired level of synchronization to be maintained. If the session being synchronized has a tolerance of two hundred milliseconds, then the threshold would be set to ensure that each client is capable of operating within a two hundred millisecond window. In another example, a fastest allowable tempo for a music session may be defined, and the threshold may be set to exclude clients having latencies that prohibit their participation at that tempo.

If the latency is less than the threshold, the method 400 continues to step 406 and accepts events from the client, thereby allowing the client to actively participate in the session. If the latency is above the threshold, the method 400 continues to step 408 and rejects events from the client. In step 410, the client may be notified of the rejection. It is understood that the method 400 may be repeated periodically to evaluate whether a client's latency is still under the threshold.

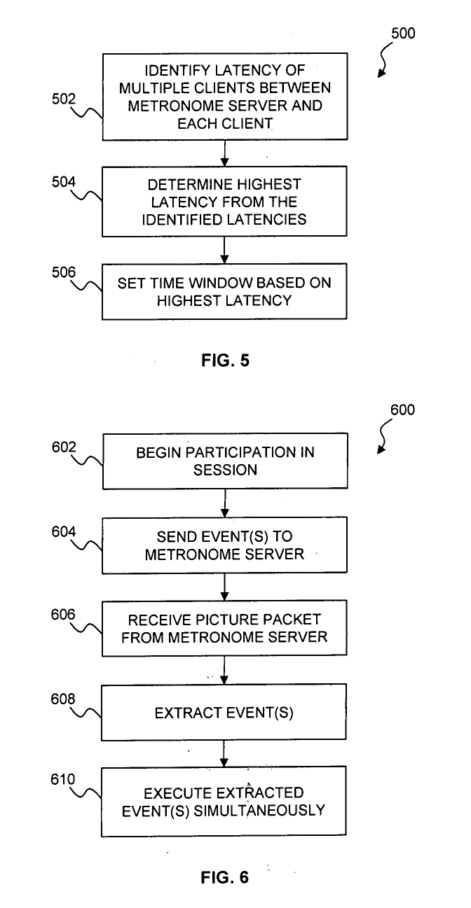

Referring to FIG. 5, in another embodiment, a method 500 may be used to set a time window size based on client latency. In the present example, the clients (e.g., the clients 202 and 204 of FIG. 2) are attempting to participate in a session that requires a relatively high level of synchronization. In step 502, a level of latency between each client 202 and 204 and a metronome server (e.g., the metronome server 220 of FIG. 2) is identified. This may be accomplished by pinging each client or by using other known processes. In step 504, the highest level of latency may be identified and, in step 506, this level may be used to set the time window size. For example, if the client 202 has a latency of fifty milliseconds and the client 204 has a latency of one hundred milliseconds, then the one hundred millisecond latency of client 204 will be used to set the time window. Accordingly, in this example, all clients may participate in the session, and the client having the highest level of latency will be used to set the synchronization tolerance level of the session.

In some embodiments, method 500 may be combined with a method such as the method 400 of FIG. 4 so that latencies above a threshold level are rejected and the highest remaining level of latency is used to set the time window size. This may ensure that a certain maximum tolerance level is maintained while allowing for synchronization optimization based on the highest latency client. For example, a particular tempo may be defined as a maximum threshold and any client having a latency that cannot satisfy the tempo requirement may not be allowed to participate. However, of the clients having acceptable latencies, the highest latency may be selected and used to set the time window. This process may be repeated periodically to reset the time window as client latencies change or as clients enter and leave the session.

Referring to FIG. 6, in another embodiment, a method 600 may be used by a client (e.g., the client 202 of FIG. 2) when involved in a session that requires a relatively high level of synchronization. For purposes of simplicity, the client 202 may communicate directly with a metronome server (e.g., the metronome server 220 of FIG. 2) in the present example, but it is understood that other servers may be involved. For example, the session may be controlled by a server different than the metronome server 220, while the metronome server may handle the formation of the picture packet as previously described.

In step 602, the client 202 may begin participating in a session by registering or taking other needed action. Continuing the previous music example, the client 202 may enter a session where other clients are creating and/or listening to music. In step 604, the client 202 may send one or more events to the metronome server 220 (if creating music). If the client 202 is not creating music, this step may be omitted and the client may simply wait for picture packets from the metronome server 220. In step 606, the client 202 receives the picture packet from the metronome server 220 and, in step 608, extracts the event information from the picture packet. In step 610, the client 202 executes the event(s) in a substantially simultaneous manner. Accordingly, if the event information is music related, the client 202 would extract the information and play the notes as defined by the events. It is understood that true simultaneous execution may be impossible due to hardware and/or software constraints of the client 202.

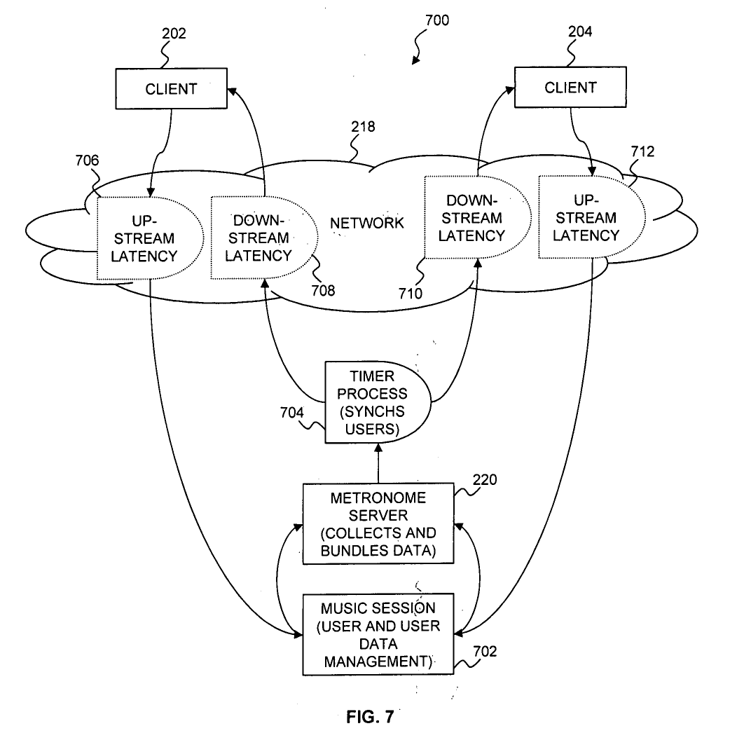

Referring to FIG. 7, in yet another embodiment, a system 700 illustrates a more detailed example of the system 200 of FIG. 2 using clients 202 and 204. For purposes of example, FIG. 7 shows music session 702 that may have multiple network participants including clients 202 and 204. Music session 702 handles user and user data management and may be on the metronome server 220 or on a separate server. Accordingly, event data from client 202 is sent to music session 702 and is affected by upstream latency 706. Similarly, event data from client 204 is sent to music session 702 and is affected by upstream latency 712. Event data is passed from music session 702 to metronome server 220, which collects and bundles the event data into a picture packet as previously described.

The metronome server 220 may include or be coupled to a timer process 704 that may be used to synchronize client communications. In the present example, the timer process 704 may identify a downstream latency 708 associated with the client 202 and a downstream latency 710 associated with the client 204. If the downstream latency of one client is higher than the downstream latency of the other client, then the timer process 704 may hold the picture packet before sending it to the client with lower latency. For example, assume that the downstream latencies 708 and 710 are one hundred and two hundred milliseconds, respectively. In this case, to synchronize the clients 202 and 204, the timer process 704 may send the picture packet to the client 204 without delay, but may introduce a delay of approximately one hundred milliseconds before sending the picture packet to the client 202. This creates an artificial downstream latency of two hundred milliseconds for the client 202 and provides a level of synchronization between the clients 202 and 204. If the client 204 is listening to the music session 702 but not actively participating in it, such delays may not be used.

Once the picture packet reaches the clients 202 and 204, they may process it as previously described. Additional events may then be sent to the music session 702 and the process may continue. In the present example, the music session 702 may be based on a protocol such as the User Datagram Protocol (UDP), and a Transmission Control Protocol (TCP) connection may be used for general data transmission and keeping sessions active with the clients 202 and 204.

In still another embodiment, data shaping may be applied to event inputs and/or data. For example, in the music session 702 of FIG. 7, a participant communicating with the music session 702 via client 202 may have little or no aptitude in the analogous real-life activity of playing a musical instrument or playing a particular musical instrument. Accordingly, a method of controlling music quality may involve shaping the data based on waveform or other factors. For example, a waveform received from the client 202 by the music session 702 may be manipulated to have a low attack and soft incline. Such an approach may allow for blending and masking missed beats. Such shaping may also aid in manipulating the session to handle events that are received during a later time window than intended.

An alternative or additional approach may involve restricting participants to the submission of notes in a single key, scale, or with some mathematical restriction. To accomplish this, a rule based system may be implemented on the client 202 that regulates the input that is available to the participant. To ensure that a certain desired level of quality is maintained for the music session, certain notes may be masked off. For example, for a given genre, some keys or key combinations may be unplayable.

In such a system, participant input for the music system may be restricted by algorithms and logic to disallow unharmonious and/or extreme dissonance in the music being played. For example, this may be achieved by first limiting the note choices available to the participant from the full range of the chromatic scale (twelve tones) down to only five notes per scale, usually a variant of the major or minor pentatonic forms. This reduction of tone choices between a full chromatic scale and a pentatonic scale is illustrated below:

Chromatic Scale (12 tones): C C# D D# E F F# G G# A A# B

Pentatonic Minor Scale (5 tones): C Eb F G Bb.

By only presenting a reduced input system of notes, a certain degree of musical harmony may be ensured among the participants. Different sessions may have different musical styles and, therefore, such a music system may have a large library of appropriate pentatonic-like scales and melodic fragments with which any input will be filtered based on the current session in progress and the musical styles appropriate for the music of that session.

Although only a few exemplary embodiments of this disclosure have been described in details above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. Accordingly, all such modifications are intended to be included within the scope of this disclosure.

What is claimed is:

1. A method comprising:
determining a latency threshold based on a musical tempo;
setting a time window based on the latency threshold, wherein events received during the time window are considered to be simultaneous;
receiving first and second events from the first and second clients, respectively, during the time window;
combining the first and second events into a picture packet after the time window ends, wherein the picture packet includes all information needed by each of the first and second clients to execute the first and second events; and
sending the picture packet to the first and second clients for execution.

2. The method of claim 1 further comprising:
receiving a third event from the first client during the first time window; and
combining the third event into the picture packet with the first and second events.

3. The method of claim 1 wherein sending the picture packet to the first and second clients for execution includes broadcasting the picture packet.

4. The method of claim 1 wherein sending the picture packet to the first and second clients for execution includes unicasting the picture packet.

5. The method of claim 4 further comprising calculating a first latency between the first client and a server and a second latency between the second client and the server.

6. The method of claim 5 further comprising calculating a first sending time for sending the picture packet to the first client based on the first latency and a second sending time for sending the picture packet to the second client based on the second latency, wherein the first and second sending times are calculated so that the picture packet arrives at the first and second clients at substantially the same time.

7. The method of claim 5 further comprising:
determining that a third latency between a third client and the server is higher than the latency threshold; and
rejecting events from the third client for inclusion in the picture packet.

8. The method of claim 8 further comprising informing the third client that the third latency exceeds the latency threshold.

9. A method comprising:
receiving a first event from a first client during a first time window;
receiving a second event from a second client during the first time window;
combining the first and second events into a picture packet, wherein the first and second events are considered to have occurred simultaneously due to their arrival within the first time window; and
sending the picture packet to the first and second clients for execution.

10. The method of claim 9 further comprising:
calculating a first latency between the first client and a server and a second latency between the second client and the server; and
determining whether the first latency is lower than the second latency, wherein if the first latency is lower than the second latency, the picture packet is sent immediately to the second client and the picture packet is held for a time period equal to the difference between the first and second latencies before being sent to the first client.

11. The method of claim 9 further comprising:
receiving a third event from the first client during a second time window, wherein the second time window follows the first time window; and
placing the third event into another picture packet prior to sending the other picture packet to the first and second clients after the second time window ends.

12. A method comprising:
sending an event to a server, wherein the event indicates a user action in a music session controlled by the server;
receiving a picture packet containing a plurality of simultaneous events from the server, wherein the picture packet includes the event sent to the server;
extracting the events from the picture packet; and
executing the events substantially simultaneously.

13. The method of claim 12 wherein the event is a musical note.

14. The method of claim 12 wherein the event is a plurality of musical notes.

15. A system comprising:
a network interface;
a processor coupled to the network interface;
a memory coupled to the processor for storing instructions for execution by the processor; and
a plurality of instructions for a metronome process, the instructions including instructions for:
receiving a first event from a first client during a time window;
receiving a second event from a second client during the time window;
combining the first and second events into a picture packet, wherein the first and second events are considered to have occurred simultaneously due to their arrival within the time window; and
sending the picture packet via the network interface to the first and second clients for execution.

16. The system of claim 15 further comprising instructions for setting the time window as a defined period of time.

17. The system of claim 15 further comprising a plurality of instructions for a timer process, the instructions including instructions for:
calculating a first latency between the first client and the network interface and calculating a second latency between the second client and the network interface; and
determining whether the first latency is lower than the second latency, wherein if the first latency is lower than the second latency, the picture packet is sent without being held to the second client and the picture packet is held for an additional time period equal to the difference between the first and second latencies before being sent to the first client.

18. The system of claim 15 wherein the metronome process is executed on a dedicated server containing the network interface, processor, and memory.

19. The system of claim 18 wherein the timer process is executed on the metronome server.

20. The system of claim 15 further comprising a plurality of instructions for a music session, the instructions including instructions for:
receiving the first and second events from the first and second clients, respectively; and
passing the first and second events to the metronome process.
